(19) United States
(12) Patent Application Publication
(10) Pub. No.: US 2010/0010775 A1
(43) Pub. Date: Jan. 14, 2010

(54) ELECTRONIC APPARATUS, TIMER ADJUSTING DEVICE, TIMER SOFTWARE, TIMER PROCESSING METHOD, AND TIMER PROCESSING PROGRAM

(75) Inventors: Takuya Ohkubo, Chiba-shi (JP); Natsuki Yuasa, Yachiyo-shi (JP); Daisuke Kamata, Suzuka-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi, Osaka (JP)

(21) Appl. No.: 12/439,492

(22) PCT Filed: Aug. 20, 2007
(86) PCT No.: PCT/JP2007/066118

§ 371 Date: Feb. 27, 2009

(30) Foreign Application Priority Data
Aug. 30, 2006 (JP) 2006-234250

(51) Int. Cl. G04G 5/00; G04F 10/00

(52) U.S. Cl. 702/178; 368/10; 368/107

(57) ABSTRACT

The present invention is characterized in that a time elapsed since activation can be retained even after a time timer is updated to time information externally acquired, by updating a value in the time timer that starts count-up after activation with the time information externally acquired, and by subtracting a value of the time timer from the acquired time information and reflecting this subtracted value into a reference time storage part.

### TECHNICAL FIELD

The present invention relates to a timer adjustment technique.

### BACKGROUND ART

A timer has been conventionally utilized for control of electronic apparatuses and the like. This conventionally-used timer generally has a configuration as shown in FIG. 10, for example. FIG. 10 is a functional block diagram showing a configuration example of time management in a digital television receiving system given as an example of common electronic apparatuses. As shown in FIG. 10, a general time management mechanism includes a timer management part 111 that manages a timer-related mechanism, a controller 115 that controls the whole apparatus, a time acquisition means 117 that acquires a time, a reference time storage part 121 that stores a reference time, and a current time timer 123. The current time timer 123 is provided with a backup power supply 125, and is thereby configured not to lose the current time. In other words, general electronic apparatuses that use the current time have a mechanism such as a RTC (Real Time Clock) or use of standby power consumption to retain the current time. Execution of some processing may be omitted by changing time information during operation. The following Patent Documents 1 and 2 describe countermeasures for such omission.

[Patent document 1] Japanese Patent Application Publication No. 2005-337614
[Patent document 2] Japanese Patent Application Publication No. 2006-103151

### DISCLOSURE OF THE INVENTION

### Problems to be Solved by the Invention

As described in the above-mentioned documents, setting of the acquired time may obstruct correct execution of processing of a running module (software module).

Moreover, digital home electric appliances and the like in which events to be processed occur frequently during operation, have problems that, due to shifts of time, some events do not occur, a certain event occurs twice, and so on, which often leads to incorrect processing. Additionally, since a clock can be incorrect, when the time information is not retained, incorrect time display is presented to a user. This also leads to another problem of confusing the user.

Furthermore, to take countermeasures against this, a battery for retaining the current time information or standby power consumption is needed, which increases costs. Since resource saving and energy saving are encouraged in the present day, the above-mentioned problem should be improved. The techniques of the above-mentioned patent documents also have problems that the procedures are complicated and are not appropriate in fields such as digital home electric appliances in which processing frequently occurs. Moreover, electrical home electric appliances and the like may employ a system which uses, not an absolute value as current time, but a difference value from one point of time to another point of time of a timer that operates using an elapsed time from any selected point of time. However, if the system does not have the mechanism such as the battery for retaining current time information and needs the elapsed time and the current time at the same time, the system needs to take countermeasures such as having several timer systems. This is also a point that needs to be improved. An object of the present invention is to solve the above-mentioned problems.

### Means for Solving the Problems

According to one aspect of the present invention, an electronic apparatus is provided, including: a current time timer that continues counting a current time after activation; a reference time storage part that retains a reference time for apparatus operation; at least one external time information acquisition part that externally acquires time information; and a timer management part that responds to an inquiry about the time information from a module with the time information, the timer management part reflecting the time information acquired by the external time information acquisition part into both the current time timer and the reference time storage part.

Moreover, an electronic apparatus is provided, including: a current time timer that includes no backup power supply and continues counting a current time after activation; a reference time storage part that retains a reference time for apparatus operation; at least one external time information acquisition part that externally acquires time information; and a timer management part that responds to an inquiry about the time information from a module with the time information, the timer management part reflecting the time information acquired by the external time information acquisition part into both the current time timer and the reference time storage part.

Preferably, the external time acquiring part is at least any one of a first external time acquiring part that acquires the time information from a broadcast wave and a second external time acquiring part that externally acquires the time information through communication. Additionally, the external time acquiring part has a comparison part that compares the current time timer with the acquired time information, and can determine whether or not to update the current time timer based on a comparison result by the comparison part. Moreover, whether or not to update the current time timer may be determined based on a difference between the current time timer and the acquired time information or based on a comparison between any selected time and the current time timer.

Moreover, preferably, when a current time is to be displayed, control is exerted so that the time may not be displayed when the time information has not been externally acquired. Moreover, preferably, when a current time is to be displayed, control may be exerted so that the time may not be displayed when the time information has not been externally acquired, although even in such a case the timer management part responds to an inquiry about the time when receiving the inquiry. The current time timer may be a timer that starts counting from a certain time before an actual time.

According to another aspect of the present invention, a timer adjusting device is provided, which is characterized by including: a current time timer that includes no backup power supply and continues counting a current time after activation; a reference time storage part that retains a reference time for apparatus operation; and a timer management part that responds to an inquiry about time information from a module with the time information, the timer management part reflecting the time information externally acquired into both the current time timer and the reference time storage part.

### Effects of the Invention

According to the present invention, it is possible to prevent occurrence of such a shift as brings about discrepancy in a timing of module operation by setting time information newly externally acquired, in a timer within the apparatus. A battery for continuing maintaining current time information is thus unnecessary.

Moreover, it is possible to display the time, not only when the time information is acquired through digital broadcasting, but also when the time information is acquired from a network environment.

Also when the time information can be acquired by other means, it is possible to display the time in the similar manner. The time is not displayed when the time information has not been acquired. This can avoid confusing a user.

### BRIEF DESCRIPTION OF THE DRAWINGS

FIG. 1 is a functional block diagram showing an example of an overall configuration of an electronic apparatus according to a first embodiment of the present invention.

FIG. 2 is a functional block diagram showing an example of a basic configuration of a portion related to a timer mechanism of the electronic apparatus.

FIG. 3 is a functional block diagram showing an example of a rough overall configuration of the electronic apparatus.

FIG. 4 is a flow chart showing a procedure of timer adjustment processing according to the embodiment.

FIG. 5 is a front view of a display unit of an electronic apparatus, showing an example of its simplified configuration, the display unit including a timer adjustment function according to a third embodiment of the present invention and performing display.

FIG. 6 is a flow chart showing a procedure of timer adjustment processing according to the embodiment.

FIG. 7 is a functional block diagram showing a configuration example of the electronic apparatus according to the embodiment.

FIG. 8 is a functional block diagram showing a configuration example of the electronic apparatus according to the third embodiment of the present invention.

FIG. 9 is a sequence diagram showing a procedure of timer adjustment processing in the electronic apparatus according to the first embodiment of the present invention.

FIG. 10 is a functional block diagram showing a configuration example of time management in a digital television receiving system shown as an example of a general electronic apparatus.

FIG. 11 is a functional block diagram showing an overall configuration diagram of the digital television receiving system as the electronic apparatus of the first embodiment of the present invention.

### EXPLANATION OF REFERENCE NUMERALS

A electronic apparatus system
1 network environment
5 electronic apparatus
10 broadcasting station
3, 7 networks
11 timer management part
15 controller (CPU) that controls the whole apparatus
17 time acquisition means
21 reference time storage part
23 current time timer

### BEST MODES FOR CARRYING OUT THE INVENTION

Hereinafter, referring to the drawings, description will be given of an electronic apparatus including a timer adjustment mechanism according to a first embodiment of the present invention. The present invention is characterized by preventing operation of other modules from being influenced by correcting a reference time for a currently operating system timer at the same time when the acquired time information is reflected into the system timer.

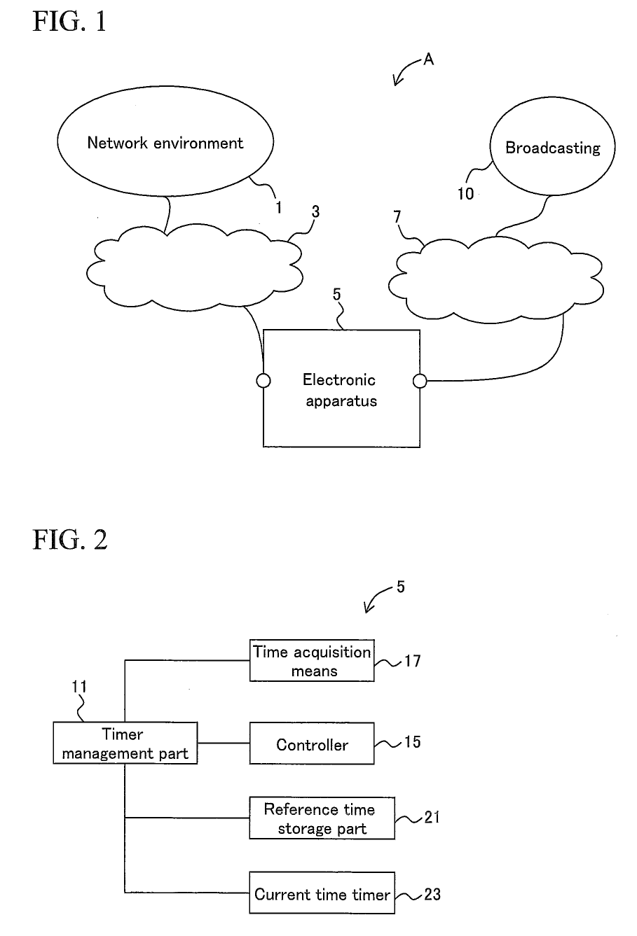

FIG. 1 is a functional block diagram showing an example of an overall configuration of an electronic apparatus according to the embodiment. As shown in FIG. 1, an electronic equipment system A according to the embodiment includes a network environment 1, an electronic apparatus 5, and a broadcasting station 10. Networks 3 and 7 are provided between the electronic apparatus 5 and the network environment 1 and between the electronic apparatus 5 and the broadcasting station 10, respectively.

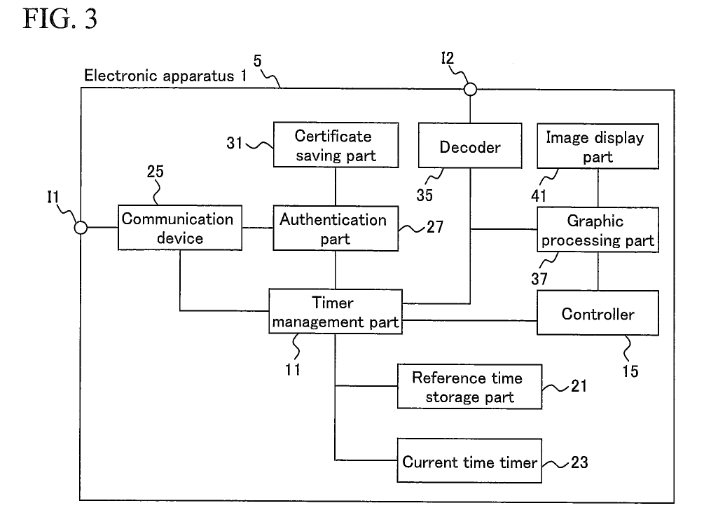

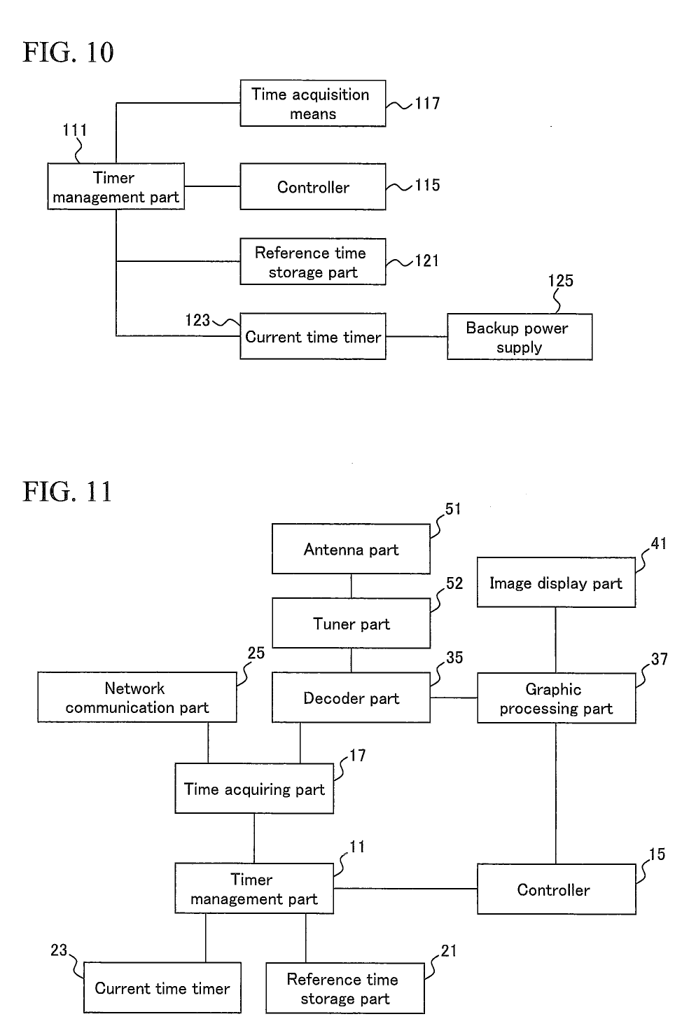

FIG. 2 is a functional block diagram showing an example of a basic configuration of a portion related to a timer mechanism of the electronic apparatus 5. FIG. 3 is a functional block diagram showing an example of a rough overall configuration of the electronic apparatus. As shown in FIG. 2, the timer mechanism of the electronic apparatus 5 according to the embodiment includes a timer management part 11 that performs timer management, a controller 15 that controls the whole apparatus, a time acquisition means 17, a reference time storage part 21, and a current time timer 23. However, as is apparent in comparison with FIG. 10, no backup power supply is provided for the current time timer 23.

As shown in FIG. 3, besides the above-mentioned timer management part 11, the reference time storage part 21, the current time timer 23, and the controller 15, the electronic apparatus 5 according to the embodiment as a whole includes a communication interface I1, a communication device 25, an authentication part 27, and a certificate saving part 31, a decoder 35, a video/voice signal interface part 12, a graphic processing part 37, and an image display part 41.

Although described above as having only the decoder part 35, the electronic apparatus 5 may, in practice, have a tuner, or a tuner and an antenna built-in, in addition to the decoder. The decoder part 35 decodes information subjected to digital codec, and passes the information to the graphic processing part 37. If the information is an image compression stream such as MPEG2-TS, time information is included. In this case, the decoder part 35 extracts the time information, and notifies the timer management part 11 of the time information. To perform such notification, either the same bus (or signal line) as that of the graphic processing part 37 or a different bus (or signal line) may be used. Instead of spontaneous notification, the decoder part 35 may respond with the time information when receiving an inquiry from the timer management part 11.

The communication device 25 is connected to an external network environment through the communication interface I1, and is a communication port including a LAN terminal, a radio communication device, and power line communications, or the like. When being connected to the network environment, the communication device 25 notifies the timer management part 11 of the time information acquired by use of NTP (Network Time Protocol) or the like. Alternatively, in order to ensure security, the time information may be acquired by using such a method that connection with a particular page is always made immediately after network connection to acquire the time information that the page has. Also in this case, without spontaneous notification, the communication device 25 may respond with the time information only when receiving an inquiry from the timer management part 11.

The timer management part 11 responds with the time information to an inquiry from the controller 15, the authentication part 27, and various modules mounted on the electronic apparatus, which are not shown, or notifies the above-mentioned components of event occurrence at any timing. When responding to an inquiry about the time information, the timer management part 11 may use a difference between the reference time and the current time timer, or a value of the current time timer itself. Which one to use is determined depending on an inquiring module or an API (Application Program Interface) to be used. In this configuration, a time elapsed since the electronic apparatus 5 has been activated is used to respond to an inquiry from the controller 15, and the value of the current time timer is used to respond to an inquiry from the authentication part 27. When the time information is acquired with the decoder 35 or the communication device 25 and the current time timer is updated, the value of the reference time stored in the reference time storage part is also updated so that the difference between the current time timer and the reference time, before updating is equal to that after updating.

In an initial state, the reference time storage part 21 retains a time of when the electronic apparatus 5 is activated. For example, in a Linux system, the time is 1970/1/1. Although existing on a common storage part, in other configurations, the reference time storage part 21 may be reserved on a register on a CPU, or on hardware with a special configuration. “Activation” means that power is supplied to the electronic apparatus (which has currently no power supplied) to thereby start the operation of the electronic apparatus.

The current time timer 23 is a timer that keeps counting up time after activation of the electronic apparatus 5. In the Linux system, the time count-up is started from 1970/1/1. When the time information is acquired with the decoder 35 or the communication device 25, the current time timer is updated to the acquired time information. Although existing on a common storage part, in other configurations, the storage part may be reserved on the register on the CPU, or on hardware with a special configuration. In the case of an example shown in the drawing, a description is given of a configuration in which software is interrupted every 1 μs by hardware not shown, to count up, and the current time timer 23 on the storage part is updated. However, of course, this count-up processing may be configured to be executed by hardware, or another configuration is also acceptable in which, for example, the reference time is not 1970/1/1, or the reference time changes whenever the electronic apparatus 5 is activated.

The controller 15 controls overall operation of the electronic apparatus 5. The controller 15 performs control for operating the decoder 35, the communication device 25, the graphic processing unit 37, and other various modules not shown, at an appropriate timing.

The authentication part 27 performs authenticating processing of a certificate, such as SSL, for secure communications. Although the authentication method is not limited to SSL, SSL is used in the present embodiment. The authentication part 27 determines validity of the certificate by comparing an expiration date of the certificate with the current time. When the certificate is determined as valid, the authentication part 27 performs a SSL authentication procedure, cryptographic key processing, and the like.

The (electronic) certificate saving part 31 stores therein an electronic certificate. The certificate saving part 31 saves an SSL certificate issued from a server. Alternatively, a part of a common storage part may be used.

The graphic processing part 37 performs processing for displaying the information received from the decoder 35 on the image display part 41. For example, the graphic processing unit 37 performs processing for appropriately displaying on the image display part 41 an image and subtitles received as MPEG-TS, control information generated by the controller 15, UI such as a menu, channel display, and a cursor, and the like.

The image display part 41 displays information processed by the graphic processing unit 37 to a user. While the electronic apparatus itself includes the display here, the electronic apparatus may be a type that displays the information on an external device (external display).

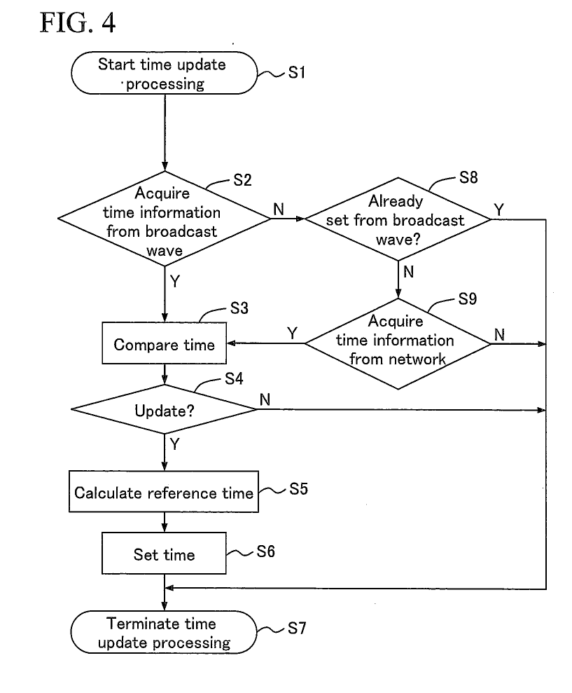

FIG. 4 is a flow chart showing a timer adjustment processing according to the present embodiment. First, at Step S1, the time notification means notifies acquisition of the time, and then time update processing for time adjustment is started. It may be configured so that this time information update processing may be started periodically or at a time of any event occurrence. Between Steps S1 and S2, processing for waiting for input of the time information may be inserted. The processing for waiting for input of the time information may employ any of the following methods: a method in which the timer management part waits for a fixed period of time and a method in which the timer management part is notified when a means for acquiring the time information, which is, in this case, the communication device or the decoder has acquired the time information. In the latter method, the notification is performed using, for example, events such as interruption, semaphore (which is a synchronization mechanism for sharing and using resources), a mail box, and an event flag.

At Step S2, determination is made of whether the time acquisition has been notified by the decoder. In the case of N, the process proceeds to Step S8, and, in the case of Y, the process proceeds to Step S3. In Step S3, a comparison is made between the time information acquired from the broadcast wave and the time of the current time timer. On the other hand, when the time information has not been acquired from the broadcast wave, the process proceeds to Step S8 to check whether the current time timer at present is already set from the broadcast wave. When the current time timer is set from the broadcast wave (Y), the process proceeds to Step S7 to terminate the time update processing. When the current time timer is not set from the broadcast wave (N), the process proceeds to Step S9 to check whether the time information has been able to be acquired from the network. When the time information has not been acquired from the network, the process proceeds to Step S7. When the time information has been able to be acquired from the network, the process proceeds to Step S3 (Y) to compare the current time timer with the time information acquired from the network and to determine whether or not to perform the time update processing.

Here, the time acquisition from the broadcast wave is preferentially taken into consideration. This is because the time information acquired from the broadcast wave generally has higher accuracy than the time information acquired from the network. Depending on a configuration of the apparatus, the time information does not necessarily have to be acquired from the broadcast wave, and it may be more preferable to acquire the time information from the network preferentially.

The current time timer is compared with the acquired time information in the time comparison processing of Step S3. At Step S4, based on the comparison result, determination is made of whether or not to update the current time timer. As a criterion for updating, a criterion that the difference between the current time timer and the acquired time information is, for example, not less than 1 s is used. Alternatively, the updating may always be performed irrespectively of the difference value. Or the difference value may be any other values such as 1 ms and 1 μs. Or, it may be configured so that any value can be set. Whether or not to update may be determined using other methods, including: updating when the value of the current time timer is before a manufacturing year (for example, 2006); determining whether or not to update depending on a value in a further-provided acquisition success and failure storage part that stores an acquired flag; updating when it is before an effective date of the SSL certificate of the authentication part; or determining whether or not to update based on a simple criterion arbitrarily set such as 1970, or 2000 or before.

Hereinafter, as an example, a case will be described where the difference value used as the criterion is set at 1 s. When it is determined that the difference is less than 1 s and that updating is not to be performed (N), the time update processing is terminated (Step S7).

When the time update processing is performed (Y), the process proceeds to Step S5, and a reference time after updating is calculated first. The reference time after updating is calculated by subtracting the value of the current time timer from the time acquired at each of the above-mentioned steps, and adding the current reference time to the value after the subtraction. When a system timer uses 1 s as a criterion unit, a value obtained by subtracting 1 s from the calculated reference time is used so that count-up for 1 s may be performed during the next step (update processing) and necessary processing may not be omitted. For example, such processing may not be needed when it is configured so that values not more than the reference time are cleared at a time of implementation by hardware or setting of the timer. Subsequently, time setting processing is performed at Step S6. The time setting processing is performed by setting the acquired time in the current time timer and setting the calculated reference time in the reference time storage part.

Here, subtraction for 1 s is performed as mentioned above because in the case of software control of the timer, shift of time at the time of software processing may become a problem. When timer control is performed with software, subtle shift may exist between before and after time updating, in a timing not more than a criterion unit of a system clock. However, a response time to interruption usually varies in the software, and therefore, it is thought that this error does not cause a problem. Turning back time causes a problem if it exceeds the reference time to prevent an event from occurring, but does not cause a problem as long as it does not exceed the reference time. The use of the calculated value is based on such considerations. Accordingly, the above-mentioned subtraction of 1 s is performed.

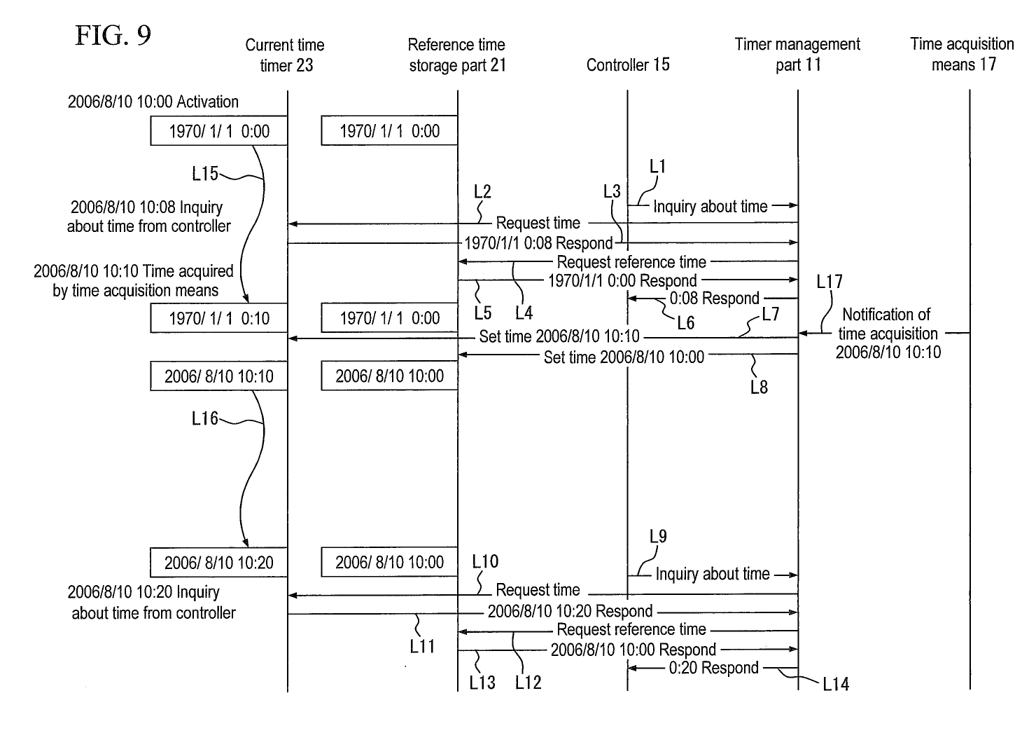

The above-mentioned processing will be more specifically described, referring to FIG. 9. FIG. 9 is a sequence diagram specifically showing details of the timer adjustment processing. Description will be given of processing in each of the current time timer 23, the reference time storage part 21, the controller 15, the timer management part 11, and the time acquisition means 17.

First, the electronic apparatus 5 is activated at 10:00 of 2006/8/10. An initial value at this time is 0:00 of 1970/1/1 in both of the current time timer 23 and the reference time storage part 21. The current time timer 23 continues counting up after activation. Suppose that the controller 15 inquires of the timer management part 11 a time elapsed since activation, at 10:08 of 2006/8/10 (L1). Then, the timer management part 11 requests provision of the time from the current time timer 23 and the reference time storage part 21 (L2, L4). The current time timer 23 responds with the value of 0:08 of 1970/1/1 (L3), and the reference time storage part 21 responds with the value of 0:00 of 1970/1/1 (L5). Based on these values, the timer management part 11 can calculate that 8 minutes have passed after activation. Accordingly, the timer management part 11 can return a reply of 0 hour and 08 minutes to the controller 15 (L6).

Suppose that the time acquisition means (decoder 35 or communication device 25 in FIG. 3) acquires the current time at 10:10 of 2006/8/10 (L15). The time acquisition means 17 notifies the timer management part 11 of acquisition of the time (L17). The timer management part 11 calculates the value used for updating in the reference time storage part 21 from the acquired current time of 10:10 of 2006/8/10 and the value of the current time timer 23. The new reference time is a value obtained by adding 00:00 of 1970/1/1 to the value obtained by subtracting 0:10 of 1970/1/1 from 10:10 of 2006/8/10. Accordingly, the value of 10:10 of 2006/8/10 is set in the current time timer 23 (L7), and the value of 10:00 of 2006/8/10 is set in the reference time storage part 21 (L8).

After this, suppose that the controller 15 inquires of the timer management part 11 the time elapsed since activation, at 10:20 of 2006/8/10 (L9). Then, the timer management part 11 requests the time from the current time timer 23 and the reference time storage part 21 (L10, L12). The current time timer 23 responds with the value of 10:20 of 2006/8/10 (L11), and the reference time storage part 21 responds with the value of 10:00 of 2006/8/10 (L13). Based on these values, the timer management part 11 can calculate that 20 minutes have passed after activation. Accordingly, the timer management part 11 returns a reply of 0 hour and 20 minutes to the controller 15 (L14). In this way, the correct elapsed time after activation is shown irrespective of the value of an absolute time set in the reference time storage part 21 and the current time timer 23 (L15, L16).

As described above, according to the timer adjustment technique according to the present embodiment, it is possible to prevent occurrence of such a shift as raises discrepancy in a timing of module operation by setting the time information newly externally acquired, in the timer within the apparatus. There is an advantage of not requiring a battery for continuing maintaining the current time information.

Next, description will be given of a second embodiment of the present invention, referring to the drawing. In the example of the configuration shown in FIG. 3 mentioned above, when the timer management part 11 is inquired about the time information to display the time, a time of the 1970s that is the initial value at the time of system startup may be returned at a stage in which the time information has not been externally acquired. If the time is displayed without change, there is a problem of confusing the user.

One solving means for this problem is to provide a time storage part 55 which stores both the time information acquired from the decoder part 35 and the time within the system acquired from the timer management part 11, as shown in FIG. 8, and gives the time information to another module for displaying the time, which is a menu display part 51 in an example in FIG. 8. Since this time storage part 55 has an invalid value (for example, 00000000) in the initial state at the time of activation, the time storage part 55 can easily determine whether it is valid time information that may be displayed.

Next, description will be given of a timer adjustment technique according to a third embodiment of the present invention, referring to the drawings. The time storage part used in the second embodiment mentioned above has no problem when using only the time information from the decoder part 35. However, when at least one or more other means for externally acquiring the time information is provided, there might be a method in which a module other than the timer management part 11 similarly manages and uses the time information. This denotes that timer management is doubly performed. From a viewpoint of the user, as long as the time information can be obtained by some sort of means, it is more convenient to display the time information.

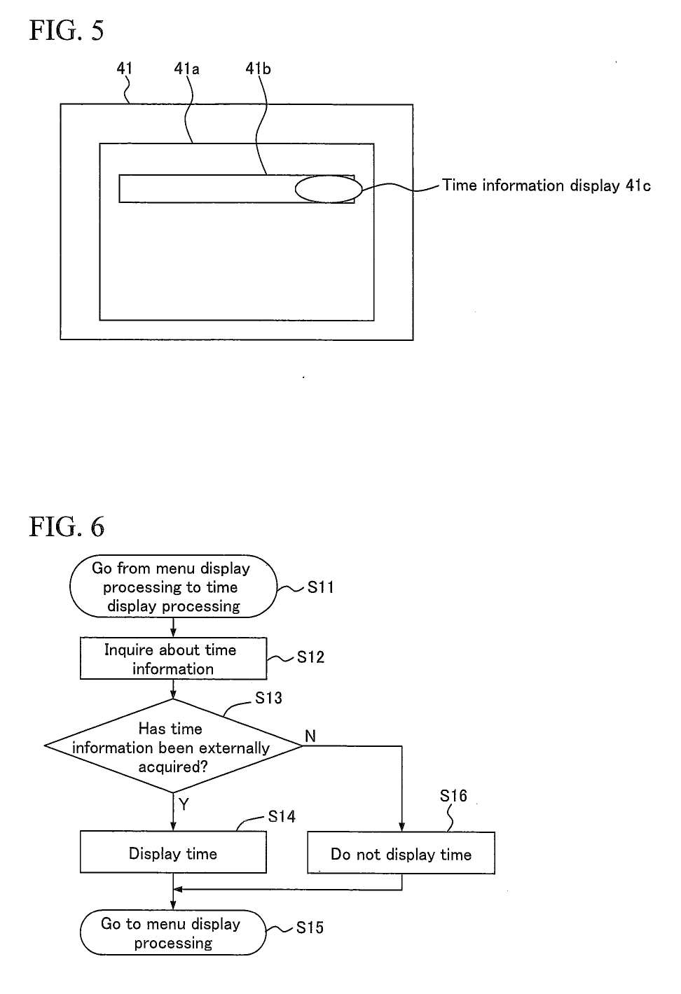

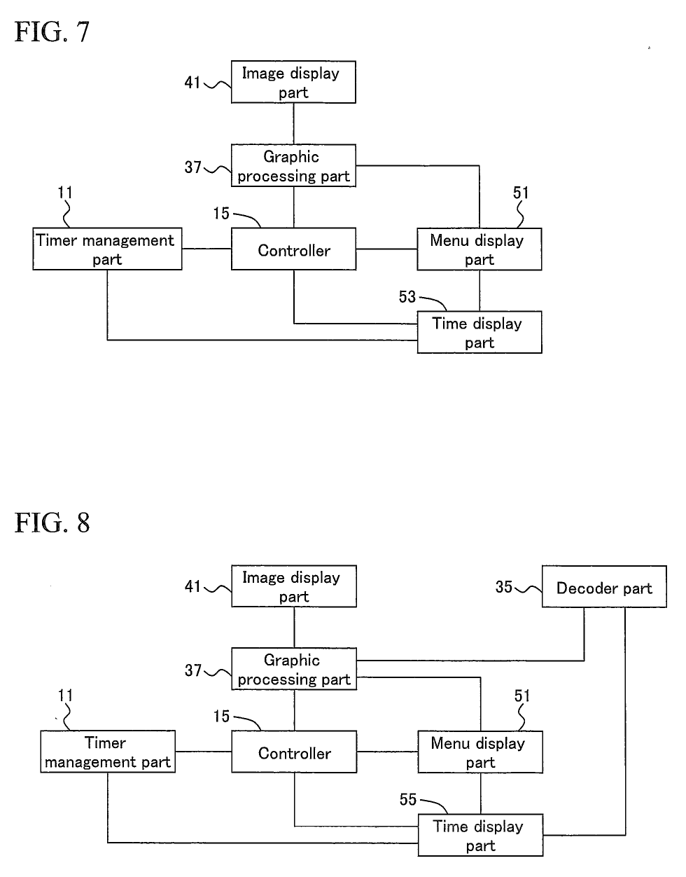

Description will be given below on a technique for displaying only time information acquired externally, among time information obtained by multiple means, without displaying unsuitable time information. FIG. 5 is a front view of a display unit of an electronic apparatus, showing an example of its simplified configuration, which display unit includes a timer adjustment function according to the embodiment and performs display. As shown in FIG. 5, a display unit 41 includes a display screen 41a and a menu bar 41b displayed therein, and is configured to display a time information display 41c at, for example, a right end of the menu bar 41b. Upon inquiry about a time to be displayed, even when time information has not been acquired from the decoder or the communication device, the timer management part responds to the inquiry with a time anyway. Here, the configuration according to the embodiment is characterized by performing processing so as not to display the time with which the timer management part has responded, on the menu bar 41a of the image display part 41a. This can prevent the user from getting confused. A detailed procedure will be described along a flowchart shown in FIG. 6. An example of the configuration will be shown in FIG. 7. As shown in FIG. 7, an electronic apparatus according to the embodiment includes a timer management part 11, a controller 15, a graphic processing part 37, an image display part 41, a menu display part 51, and a time display part 53.

As shown in FIG. 6, at Step S11, first, processing is passed from the menu display processing part to the time display unit. Subsequently, an inquiry about the time is made to the timer management part at Step S12. At Step S13, it is checked whether the time information has been externally acquired. Checking methods that may be employed here include: determining that the time information has not been acquired when a value of the current time timer is before a manufacturing year (for example, 2006) in the case of a system having the current time timer started from 1970/1/1, or providing an acquisition success and failure storage part that stores an acquired flag. Alternatively, it may be determined that the time information has not been acquired when the value of the current time timer is before an effective date of the SSL certificate of the authentication part, or it may be determined that the time information has not been acquired simply based on any set criterion such as 1970, 2000 or before. Here, when the time has been acquired (Y), the time is displayed at Step S14. When the time has not been acquired (N), at Step S16, control is exerted so that the time may not be displayed. At this time, processing such as filling in the display unit with the same color as that of the menu bar may be performed in advance so that the display may not look unnatural to the user. In either case, the process proceeds to Step S15 to proceed to menu display processing.

As described above, according to the present embodiment, there is an advantage of preventing display of a time different from the current time for a system-related reason.

Other external apparatuses will be described. While the electronic apparatuses connectable to broadcasting or to the network environment has been described as an example in the above-mentioned embodiments, besides this, the present invention can be used in apparatuses that can acquire the time information through connection with external apparatuses such as power line communications networks, digital television receiving systems, DVD recorders, DVD players, television tuners, refrigerators, washing machines, cookware, apparatuses or systems for electric power generation or storage.

As an example of the electronic apparatus according to the first embodiment of the present invention, an overall configuration diagram of a digital television receiving system is exemplified in FIG. 11. In addition to the principal part of the configuration of the electronic apparatus 5 shown in FIG. 3, the digital television receiving system shown in FIG. 11 includes an antenna part 51 that receives digital broadcasting, and a tuner part 52 that tunes in the broadcasting. A tuned digital broadcasting signal is decoded in the decoder part 35. In this case, the time information can be acquired in the network communication part (communication device) 25, or the time information can be acquired through the digital broadcasting. The technique according to the present invention is applicable in a similar manner to the other electronic apparatuses exemplified in the above description, as long as the other electronic apparatuses have a mechanism with which the time information can be similarly acquired externally.

As described above, in the present embodiment, the time can be displayed not only when the time information is acquired through the digital broadcasting, but also when the time information is acquired from the network environment. Furthermore, when the time information can be acquired by other means, the time can be displayed in a similar manner. There is an advantage of preventing the user from getting confused by not displaying the time when the time information has not been acquired.

### INDUSTRIAL APPLICABILITY

The present invention is applicable to timer adjustment of electronic apparatuses.

1-17. (canceled)

18. An electronic apparatus, comprising:
a time timer that starts count-up after activation;
at least one external current time acquisition part that externally acquires a current time; and
a timer management part that responds to an inquiry about time information from a module with the time information,
the electronic apparatus characterized in that the timer management part includes:
a first function to respond to the inquiry about the time information from the module with the current time after the current time acquired by the external current time acquisition part is reflected into the time timer; and
a second function to respond with a time elapsed since activation.

19. An electronic apparatus, comprising:
a time timer that starts count-up after activation;
a reference time storage part that retains a reference time of the apparatus;
at least one external current time acquisition part that externally acquires a current time; and
a timer management part that responds to an inquiry about time information from a module with the time information,
the electronic apparatus characterized in that the timer management part includes:
a first function of responding with the current time after the current time acquired by the external current time acquisition part is reflected into both the time timer and the reference time storage part; and
a second function of responding with a time elapsed since activation.

20. An electronic apparatus, comprising:
a time timer that includes no backup power supply and starts count-up after activation;
a reference time storage part that retains a reference time of the apparatus;
at least one external current time acquisition part that externally acquires a current time; and
a timer management part that responds to an inquiry about time information from a module with the time information,
the electronic apparatus characterized in that the timer management part includes:
a first function of responding with the current time after the current time acquired by the external current time acquisition part is reflected into both the time timer and the reference time storage part; and
a second function of responding with a time elapsed since activation.

21. The electronic apparatus according to claim 18, characterized in that the external current time acquisition part is at least any one of a first external current time acquisition part that acquires the current time from a broadcast wave, and a second external current time acquisition part that externally acquires the current time through communication.

22. The electronic apparatus according to claim 18, comprising:
a comparison part that compares a value of the time timer with the current time acquired from the external current time acquisition part;
the electronic apparatus characterized in that whether or not to update the time timer is determined based on a comparison result by the comparison part.

23. The electronic apparatus according to claim 22, characterized in that whether or not to update the time timer is determined based on a difference between the value of the time timer and the current time acquired from the external current time acquisition part.

24. The electronic apparatus according to claim 18, characterized in that whether or not to update the time timer is determined based on a comparison between any selected time and the time in the time timer.

25. The electronic apparatus according to claim 18, further characterized in that when the current time is to be displayed, control is exerted so that the time is not displayed when the current time has not been able to be externally acquired.

26. The electronic apparatus according to claim 18, further characterized in that when the current time is to be displayed, control is exerted so that the time is not displayed when the current time has not been able to be externally acquired, although even in such a case the timer management part responds to an inquiry about the time anyway when receiving the inquiry.

27. The electronic apparatus according to claim 18, characterized in that the time timer is a timer that starts counting from a certain time before an actual time.

28. A timer adjusting device, comprising:
a time timer that includes no backup power supply and starts count-up after activation;
a reference time storage part that retains a reference time of the apparatus;
at least one external current time acquisition part that externally acquires a current time; and
a timer management part that responds to an inquiry about time information from a module with the time information,
the time adjusting device characterized in that the timer management part includes:
a first function of responding with the current time after the current time acquired by the external current time acquisition part is reflected into both the time timer and the reference time storage part; and
a second function to respond with an elapsed time after activation.

29. Timer software for enabling a computer to execute functions as:
a time timer that includes no backup power supply and starts count-up after activation;
a reference time storage part that retains a reference time of the apparatus;
at least one external current time acquisition part that externally acquires a current time; and
a timer management part that responds to an inquiry about time information from a module with the time information,
in the timer management part, the timer software further enabling a computer to execute:
a first function of responding with the current time after the current time acquired by the external current time acquisition part is reflected into both the time timer and the reference time storage part; and
a second function of responding with a time elapsed since activation.

30. An electronic apparatus, comprising:
a time timer that starts count-up from an initial value of a system after activation;
a reference time storage part that maintains a reference time of the apparatus, the reference time storage part storing the initial value of the system at the activation;
at least one external current time acquisition part that externally acquires time information; and
a timer management part that is notified by the external time information acquisition part of acquisition of the time when the external time information acquisition part externally acquires the current time, the timer management part calculating the reference time from both the current time externally acquired and a value of the time timer, and setting the acquired current time in the time timer and the reference time in the reference time storage part;
the electronic apparatus characterized in that when inquired about time information from a module, the timer management part requests times from the time timer and the reference time storage part, calculates an elapsed time according to the replies from the time timer and the reference time storage part, and responds to the module with the elapsed time.

31. An electronic apparatus, comprising:
a time timer that starts count-up from an initial value of a system after activation;
a reference time storage part that retains a reference time of the apparatus, the reference time storage part storing the initial value of the system at the activation;
at least one external current time acquisition part that externally acquires a current time; and
a timer management part that responds to an inquiry about the time elapsed since activation from a module with, as a time elapsed since activation, a value obtained by subtracting a value of the reference time stored in the reference time storage part from a value of the time timer, the timer management part reflecting a certain value into the reference time storage part when the external time information acquisition part externally acquires the time information, the certain value being obtained by subtracting a value of the time timer at that point from the acquired time information and further adding the value of the reference time stored in the reference time storage part to the value after subtraction, the timer management part then reflecting the acquired time information into the time timer without change.

32. A timer processing method for an electronic apparatus, comprising the steps of:
starting count-up of a time timer from an initial value of a system after activation;
storing the initial value of the system in a reference time storage part that retains a reference time of the apparatus, at the activation;
an external time information acquisition part notifying a timer management part of acquisition of a time when externally acquiring the current time, the timer management part calculating a reference time from both the current time externally acquired and a value of the time timer, and the timer management part setting the acquired current time in the time timer and the reference time in the reference time storage part;
in response to an inquiry about time information from a module, the timer management part requesting times from the time timer and the reference time storage part, calculating an elapsed time according to the replies from the time timer and the reference time storage part, and responding to the module with the elapsed time.

33. A timer processing method in an electronic apparatus, comprising the steps of:
starting count-up of a time timer from an initial value of a system after activation;
storing the initial value of the system in a reference time storage part that retains a reference time of the apparatus, at the activation;
in response to an inquiry about the time elapsed since activation from a module, responding with, as a time elapsed since activation, a value obtained by subtracting a value stored in the reference time storage part from a value of the time timer; and
externally acquiring the time information, reflecting a certain value into the reference time storage part, the certain value being obtained by subtracting a value of the time timer at that point from the acquired time information, and further adding the value of the reference time stored in the reference time storage part to the value after subtraction, and then, reflecting the acquired time information into the time timer without change.

34. A program for enabling a controller to execute the timer processing method according to claim 32.
